(19) United States
(12) Patent Application Publication
(10) Pub. No.: US 2024/0228787 A1
(43) Pub. Date: Jul. 11, 2024

(54) USE OF POLYETHERS FOR PIGMENT DISPERSIONS

(71) Applicant: BASF SE, Ludwigshafen am Rhein (DE)

(72) Inventors: Ahmet Uener, Ludwigshafen (DE); Achim Fessenbecker, Ludwigshafen (DE)

(21) Appl. No.: 18/285,565

(22) PCT Filed: Apr. 7, 2022
(86) PCT No.: PCT/EP2022/059180

§ 371 Date: Oct. 4, 2023

(30) Foreign Application Priority Data
Apr. 9, 2021 (EP) 21167616.8

(51) Int. Cl. C09C 1/02; C09D 7/45; C09D 17/00

(52) U.S. Cl. CPC C09C 1/021; C09D 7/45; C09D 17/004; C01P 2004/51; C01P 2006/10; C01P 2006/22; C01P 2006/60

(57) ABSTRACT

The present invention relates to the use of a polymer containing acid groups as a dispersant for stabilising an aqueous inorganic pigment slurry, wherein the polymer containing acid groups comprises polyether groups of the structural unit (I) *—U—X-(AlkO)ₙ—W (I) where * indicates the bonding site to the polymer containing acid groups. U represents a chemical bond or an alkylene group having 1 to 8 carbon atoms. X is oxygen or an NR¹ group, n is an integer with a mean, based on the polymer containing acid groups, in the range from 3 to 300, Alk is C₂-C₄-alkylene, where Alk may be the same or different within the (Alk-O)ₙ group, W is a hydrogen, C₁-C₆-alkyl or aryl radical or is the Y—F group where Y is a linear or branched alkylene group which has 2 to 8 carbon atoms and may bear a phenyl ring, F is a nitrogen-bonded 5- to 10-membered nitrogen heterocycle which may have, as ring members, as well as the nitrogen atom and as well as carbon atoms, 1, 2 or 3 additional heteroatoms selected from oxygen, nitrogen and sulphur, where the nitrogen ring members may have an R² group, and where 1 or 2 carbon ring members may be in the form of carbonyl groups, R¹ is hydrogen, C₁-C₄-alkyl or benzyl, and R² is hydrogen, C₁-C₄-alkyl or benzyl, wherein the inorganic pigment slurry is selected from the group consisting of titanium dioxide slurry, calcium hydroxide slurry, ultrafine precipitated calcium carbonate (PCC) slurry and ground calcium carbonate (GCC) slurry. The invention provides pigment slurries having improved viscosity characteristics together with improved stability over time.

### FIELD OF THE INVENTION

The present invention relates to the use of polymeric dispersants for producing aqueous inorganic pigment slurries, wherein the inorganic pigment slurry is selected from the group consisting of titanium dioxide slurry, calcium hydroxide slurry, ultrafine precipitated calcium carbonate (PCC) slurry and ground calcium carbonate (GCC) slurry. The invention is suitable for producing such aqueous inorganic pigment slurries of high solids and improved viscosity over time.

### BACKGROUND OF THE INVENTION

Inorganic pigments often consist of dry ground minerals, usually metals and metal salts, and typically used for imparting colour in a number of applications. Examples of inorganic pigments include titanium dioxide, kaolin, china clay, talc, calcium hydroxide, ultrafine precipitated calcium carbonate, ground calcium carbonate, black pigments such as iron (III) oxide or titanium (III) oxide or manganese oxide. Typical applications include the manufacture of many products such as paper, card or other paper products, plastics, paint or other coatings. Aqueous dispersions of pigments are generally used to contribute to the mechanical and optical properties of the products into which they are applied.

It is common practice to employ dispersants to help stabilise the aqueous suspensions of the pigment. A wide variety of dispersants are known for dispersing and/or stabilising aqueous suspensions of pigments so as to reduce or prevent the settling of pigment particles in suspension. Such dispersants include, for instance, silicates or phosphates, phosphonates or oligomeric species carrying functional groups.

It is well known to use polymers for dispersing and stabilising pigments in suspension. Polymeric dispersing agents may be natural, seminatural or synthetic. Such polymers usually carry ionic groups and often have relatively low molecular weights. Examples of natural or seminatural polymers include products derived from natural polymers such as starch or cellulose, for instance de-polymerised carboxylated cellulose.

DE 10311617 A1 describes the use of polyacrylic acids having a mean molecular weight of 5000 to 30,000 g/mol and sulphur-containing organic end groups which have been at least partially neutralised with an alkali metal hydroxide or ammonium as grinding auxiliaries for producing calcium carbonate suspensions.

U.S. Pat. No. 4,840,985 describes partly neutralised acrylic acid polymer is as a grinding auxiliary for the preparation of aqueous mineral suspensions which are used as pigment suspensions. 40% to 80% of the acid groups of acrylic acid polymer is have been neutralised with alkali metal ions, ammonium ions or polyvalent cations.

U.S. Pat. Nos. 5,432,238 and 5,432,239 each describe polymers and copolymers of acrylic acid which have been neutralised with magnesium ions and sodium ions as grinding and dispersing auxiliary for preparation of mineral suspensions. According to U.S. Pat. No. 5,432,238, for this purpose, a polymer fraction obtained by fractionation and having a specific viscosity of 0.3 to 0.8 and a weight average molecular weight of 1000-10,000 g/mol is used.

U.S. Pat. No. 7,956,211 discloses the preparation of polyacrylic acids having low polydispersity index (PDI) using sulphur containing organic molecular weight regulators by RAFT polymerisation. The products can be used as grinding against for aqueous mineral suspensions.

EP 1074293 discloses phosphonate terminated polyacrylic acid and having a molecular weight Mw of 2000 to 5800 g/mol as a dispersant for the production of aqueous slurries of calcium carbonate, kaolin, clay, talc and metal oxides having a solids content of at least 60 wt %.

WO 2010/063757 discloses process for manufacturing calcium carbonate materials having a particle surface with improved absorption properties using at least one lithium ion containing compound.

WO 2014/012720 relates to a process for producing calcium sulphate dihydrate by reacting a water-soluble calcium compound with a water-soluble sulfate compound in the presence of water and a polymer containing acid groups, wherein the polymer containing acid groups comprises specific polyether groups. This reference also discloses the use for the production of gypsum plaster board.

WO 2017/032719 describes a process for producing composition suitable as an accelerator for the hardening of cement, wherein the components aa) at least one component selected from the group of hydraulic binders and/or latently hydraulic binders and bb) at least one dispersant suitable for the dispersion of inorganic pigments in water and cc) water are contacted with one another, where the weight ratio of the components aa) to cc) is between 1.5:1 and 1:70, where the weight ratio of components aa) to bb) is between 20:1 and 1:2.

WO 2018/029095 discloses a composition in the form of a solid, which composition is suitable as a dispersant for inorganic solid suspensions, comprising A) at least one water-soluble polymer, comprising polyether groups, and b) at least one water-soluble condensation product, which contains acid groups and/or salts thereof and which is based on monomers, wherein the monomers comprise at least a) a monomer having a ketone residue and B) formaldehyde.

Susanne Julia KOCH; Thèse Présentée Pour Obtenir Le Grade De Dendritic surface modification of photocatalytic nanoparticles for tumour therapy Membres du jury, 12 Oct. 2017 (2017-10-12), XP055845556, URL: http://www.theses.fr/2017BORD0687.pdf. This reference concerns the field of cancerization of tumours in the head and neck region. Due to these widespread premalignant and malignant alterations, it is frequently not possible to entirely remove the tumour by surgery. This results in a high risk of tumour recurrence. The aim of the research was to develop photocatalytic nanoparticles as completion of traditional tumour therapy. These nanoparticles are supposed to be incorporated by tumour cells and to induce photocatalytic cell death by UV light activation. Titanium dioxide with convincing photocatalytic properties and an average size smaller than 20 nm should therefore be synthesised. The reference describes the use of polycarboxylate ethers (like Melflux® 4930 F, Melpers® V4343 and Sika® ViscoCrete® 10110178) as combined ionic and steric surfactants and stabilising agents.

WO 2013/144137 sets out to provide a method for preparing calcium carbonate suspensions having a reduced content of latex-based binder. This reference also has the objective of preparing such calcium carbonate suspensions such that an obtained paper coating formulation has a rheology that is stable over time in the presence of sodium silicate and/or sodium hydroxide. This is said to be achieved by preparing an aqueous calcium carbonate suspension that involves providing a calcium carbonate containing material as an aqueous cake or suspension with a solids content of at least 45 wt. % based on the total weight of aqueous cake or suspension; providing at least one alkali metal salt of a phosphonic acid in an amount from 0.01 to 5 wt.-%, based on the total dry weight of calcium carbonate; providing at least one phosphonic acid in an amount from 0.001 to 0.5 wt.-%, based on the total dry weight of calcium carbonate. The calcium carbonate is contacted with the at least one alkali metal salt of phosphonic acid so as to obtain a suspension having a pH from 10 to 14; then contacting this suspension with at least one phosphonic acid in order to obtain a suspension of pH from 8 to 10; followed by optionally grinding the suspension.

CN 105836782 A provides preparing a calcite type calcium carbonate, comprising the steps of: (1) adding to a carbonate solution any of the following solutions including a silicate solution, a mixed solution of silicate solution and a water-soluble polymer solution, or mixed solution of silicate solution and a surfactant solution and then adding a calcium salt solution and mixing; (2) the pH of the reaction liquid obtained in step (1) is adjusted to 10-13, preferably 11-12, more preferably 11.5; (3) resting the reaction; and (4) filtering and drying. The concentration of the carbonate solution is said to be 400-1500 mg/L, preferably 800-1000 mg/L, more preferably 960 mg/L. The concentration of silicate solution is said to be 100-300 mg/L, preferably 120-180 mg/L, more preferably 150 mg/L. The concentration of the calcium salt solution is 400-800 mg/L, preferably 500-700 mg/L, more preferably 640 mg/L. The ratio of the amount of calcium ions to carbonate ions is 1:2 to 2:1, preferably 1:1.5 to 1:1, more preferably 1:1.2. The concentration of water-soluble polymer solution is 10-1000 mg/L and the concentration of the surfactant solution is 10-200 mg/L. Water-soluble polymer is said to be a partially hydrolysed polyacrylamide having a degree of hydrolysis of 25-35%, preferably 28 to 32%, more preferably 31% and the molecular weight of the hydrolysed polyacrylamide is said to range from 500 to 25 million, preferably from 9 to 19 million, more preferably 15 million.

US 2018/0282172 describes a method of preparing precipitated calcium carbonate aqueous suspensions by employing a method that involves slaking a calcium oxide containing material in water in the presence of at least one copolymer. The copolymer is said to be obtained by the polymerisation of maleic anhydride and of styrene, which may or may not be functionalised.

US 2019/0276568 sets out to provide calcium carbonate suspensions which have a low viscosity and very good pumpability even after a storage time of 3 weeks. The suspensions employ acrylic acid polymer is having a weight average molecular weight of 3,500 to 12,000 g/mole and a narrow molecular weight distribution in which 30% to 6% of the acid groups have been neutralised with calcium ions, 30 to 70% of the acid groups have been neutralised with sodium ions and not more than 10% of the acid groups have not been neutralised.

Polymeric dispersants containing polyether chains are known. Typically, these materials are polyalkylene oxide esters of polymerisable acid and/or compounds containing large hydrophobic groups.

EP 892020 describes the use of a copolymer as a dispersing agent and/or grinding agent for mineral materials in aqueous suspension. The polymer is said to be formed from (a) at least one ethylenically unsaturated monomer with carboxyl function selected from acids including acrylic acid and methacrylic acid and (d) at least one oxyalkylated ethylenically unsaturated monomer terminated by a hydrophobic chain selected from tristyrylphenyl radical or linear or branched alkyl, alkylaryl, arylalkyl and aryl groups having at least 30 carbon atoms or dialkyl amines having at least 22 carbon atoms. The polymerisable group onto which the oxyalkylated moiety is bonded is selected from acrylic, methacrylic, maleic, itaconic, crotonic and vinyl phthalic esters and urethane unsaturated.

French patent 2810261 describes a weakly anionic and hydro soluble copolymer as a dispersing agent for pigments and/or mineral fillers in aqueous suspension. The copolymer contains at least one anionic ethylenically unsaturated monomer with monocarboxylic function selected from acrylic acid or methacrylic acid or hemi esters of diacids and at least one ethylenically unsaturated monomer which is a hydrogen or methyl terminated polyalkylene oxide bonded at the other end to an unsaturated polymerisable moiety selected from esters of acrylic, methacrylic, maleic, itaconic, crotonic, vinyl phthalic acids and unsaturated urethanes.

Many aqueous inorganic pigment slurries tend to have pHs greater than 7. Certain polymeric dispersants may suffer problems of maintaining low viscosity and stability over longer periods of time. This is especially so where the slurries are of higher pH, for instance pHs of at least 8, more so where the pH is at least 8.5 and even more so where the pH is at least 9. It is not uncommon for some inorganic pigment slurries to have a pH within range from 8 to 12.5 or above.

There is an increasing requirement to provide aqueous inorganic pigment slurries which are both high solids and low viscosity where the inorganic pigment slurry is selected from the group consisting of titanium dioxide slurry, calcium hydroxide slurry, ultrafine precipitated calcium carbonate (PCC) slurry and ground calcium carbonate (GCC) slurry. This is especially so where the inorganic pigment is selected from the group consisting of calcium hydroxide and ultrafine calcium carbonate, including ultrafine precipitated calcium carbonate and ultrafine ground calcium carbonate. An objective of the present invention is to provide a dispersant which enables high solids aqueous slurries of these inorganic pigments to exhibit acceptable or lower viscosities. It is also an important objective to achieve acceptable or improved solids content with acceptable or improved viscosity with increased stability of the slurry. This is especially so for such inorganic pigment slurries having alkaline pH. A still further objective is to achieve optimum dose efficiency in combination with low or acceptable viscosities with high solids aqueous inorganic pigment slurries of titanium dioxide, ground calcium carbonate (GCC) but especially calcium hydroxide and ultrafine precipitated calcium carbonate (PCC).

### SUMMARY OF THE INVENTION

The present invention provides the use of a polymer containing acid groups as a dispersant for stabilising an aqueous inorganic pigment slurry, wherein the polymer containing acid groups comprises polyether groups of the structural unit (I)

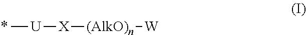

where
* indicates the bonding site to the polymer containing acid groups,
U represents a chemical bond or an alkylene group having 1 to 8 carbon atoms,
X is oxygen or an NR¹ group,
n is an integer with a mean, based on the polymer containing acid groups, in the range from 3 to 300,
Alk is C₂-C₄-alkylene, where Alk may be the same or different within the (Alk-O)ₙ group, preferably Alk is C₂-C₄ and more preferably Alk is C₂,
W is a hydrogen, C₁-C₆-alkyl or aryl radical or is the Y—F group where
Y is a linear or branched alkylene group which has 2 to 8 carbon atoms and may bear a phenyl ring,
F is a nitrogen-bonded 5- to 10-membered nitrogen heterocycle which may have, as ring members, as well as the nitrogen atom and as well as carbon atoms, 1, 2 or 3 additional heteroatoms selected from oxygen, nitrogen and sulphur, where the nitrogen ring members may have an R² group, and where 1 or 2 carbon ring members may be in the form of carbonyl groups,
R¹ is hydrogen, C₁-C₄-alkyl or benzyl, and
R² is hydrogen, C₁-C₄-alkyl or benzyl,
wherein the inorganic pigment slurry is selected from the group consisting of titanium dioxide slurry, calcium hydroxide slurry, ultrafine precipitated calcium carbonate (PCC) slurry and ground calcium carbonate (GCC) slurry.

### DETAILED DESCRIPTION OF THE INVENTION

It has been found, unexpectedly, that aqueous inorganic pigment slurries produced by the inventive use have for a given high solids exhibit reduced viscosity characteristics.

Furthermore, it has been shown that the use according to the present invention enables aqueous inorganic pigment slurries to be produced with improved stability for longer periods of time. These significantly improved viscosity properties lead to better flow characteristics, for example when pumping or feeding the slurries, dispersing or applying the slurries. The improvements in stability over periods of time are important for storage enabling the slurries produced according to the invention to be used effectively even after longer storage periods.

An important aspect of the polymer employed in the inventive use is the presence of acid groups. The term “acid group” in the present invention is understood to mean both free acid and the salts thereof.

The acid may preferably be at least one from the group of carboxyl, phosphono, aromatic acids, carbolic acids, sulphino, sulpho, sulphamido, sulphoxy, sulphoalkyloxy, sulphinoalkyloxy and phosphonooxy group. Particular preference is given to carboxyl and phosphonooxy groups.

The polymer of the inventive use may be a polycondensation product or it may be a vinyl addition polymer.

In one preferred embodiment, the polymer is a polycondensation product containing acid groups. The polycondensation product preferably comprises structural unit having an aromatic or heteroaromatic system, and a polyether group. More preferably still, the polycondensation product comprises a phosphated structural unit having an aromatic or heteroaromatic system.

In a particularly preferred embodiment, the polymer containing acid groups is a polycondensation product comprising

(II) a structural unit having an aromatic or heteroaromatic system and a polyether group of the formula (I) and

(III) a phosphated structural unit having an aromatic or heteroaromatic system.

The structural units (II) and (III) are preferably represented by the following general formulae

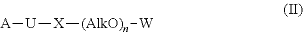

where

A is the same or different and is represented by a substituted or unsubstituted, aromatic or heteroaromatic compound having 5 to 10 carbon atoms in the aromatic system, where the further radicals are as defined for structural unit (1);

U, X, Alk, n and W all have the same definitions as those given for general formula (I).

Preferably, X is O.

Preferably, Alk is ethylene or propylene and more preferably ethylene.

Preferably, W is H

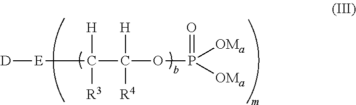

where

M is independently of one another an alkali metal ion, alkaline earth metal ion, ammonium ion, organic ammonium ion and/or H, a is 1 or in the case of alkaline earth metal ions 1/2.

D is the same or different and is represented by a substituted or unsubstituted, aromatic or heteroaromatic compound having 5 to 10 carbon atoms in the aromatic system.

In addition, E is the same or different and is represented by N, NH or O, m=2 if E=N and m=1 if E=NH or O.

R³ and R⁴ are the same or different and are each independently represented by a branched or unbranched C₁- to C₁₀-alkyl radical, C₅- to C₈-cycloalkyl radical, aryl radical, heteroaryl radical or H, preferably by H, methyl, ethyl or phenyl, more preferably by H or methyl and especially preferably by H. In addition, b is the same or different and is represented by an integer from 0 to 300. If b=0, E=O.

The polycondensation product preferably contains a further structural unit (IV) which is represented by the following formula

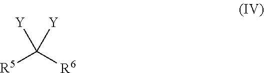

where

Y is the same or different and is independently represented by (II), (III) or further constituents of the polycondensation product.

R⁵ and R⁶ are preferably the same or different and are represented by H, CH₃, COOH or a substituted or unsubstituted, aromatic or heteroaromatic compound having 5 to 10 carbon atoms. In this context, R⁵ and R⁶ in structural unit (IV) are preferably each independently represented by H, COOH and/or methyl.

In a particularly preferred embodiment, R⁵ and R⁶ are each represented by H.

More preferably, the structural units (II) and (III) are represented by the following general formulae

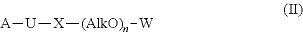

where

A is the same or different and is represented by a substituted or unsubstituted, phenyl group, where the further radicals are as defined for structural unit (I);

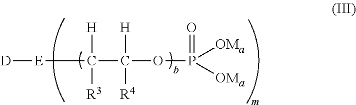

where

D is the same or different and is represented by a substituted or unsubstituted, phenyl group

where

E is the same or different and is represented by O where

m=1.

More preferably still, the structural unit (II) is represented by the following general formula

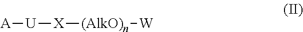

where

A is the same or different and is represented by a substituted or unsubstituted, phenyl group,

where

U is a single bond

where

X=O

where

AlkO is an ethyleneoxy and/or propyleneoxy unit,

where

n is in the range of from 10 to 150,

where

W=H.

In a more preferred embodiment, the condensation product also comprises structural unit (VII) an is represented by the following general formula

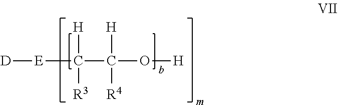

wherein D, E, R³, R⁴, b and m have the same meanings as defined above in regard to formula (II).

The molar ratio of the structural units (II), (III) and (IV) of the inventive phosphated polycondensation product can be varied within wide ranges. It has been found to be appropriate that the molar ratio of the structural units [(II)+(III)]:(IV) is 1:0.8 to 3, preferably 1:0.9 to 2 and in one more preferred embodiment 1:0.95 to 1.

The molar ratio of the structural units (II):(III) is normally 1:10 to 10:1, often 1:7 to 5:1, preferably 1.5:1 to 1:5, more preferably 3:1.2 to 1:5, more preferably 1:1 to 1:3.

The A and D groups in the structural units (II) and (III) of the polycondensation product are usually represented by phenyl, 2-hydroxyphenyl, 3-hydroxyphenyl, 4-hydroxyphenyl, 2-methoxyphenyl, 3-methoxyphenyl, 4-methoxyphenyl, naphthyl, 2-hydroxynaphthyl, 4-hydroxynaphthyl, 2-methoxynaphthyl, 4-methoxynaphthyl, preferably phenyl, where A and D may be selected independently of one another and may also each consist of a mixture of the compounds mentioned. The X and E groups are preferably each independently represented by O.

Preferably, n in structural unit (II) is represented by an integer from 5 to 280, more preferably from 10 to 160, even more preferably from 12 to 150. Suitably, b in structural unit (III) by an integer from 0 to 10, preferably 1 to 7 and more preferably 1 to 5. The respective radicals, the length of which is defined by n and b, may consist here of uniform component groups, but it may also be appropriate that they are a mixture of different component groups. In addition, the radicals of the structural units (II) and (III) may each independently have the same chain length, in which case n and b are each represented by a number. However, it will generally be appropriate that mixtures with different chain lengths are involved in each case, such that the radicals of the structural units in the polycondensation product have different numerical values for n and, independently, from b.

In a particular embodiment, the present invention further envisages that a sodium, potassium, ammonium and/or calcium salt and preferably a sodium and calcium salt of the phosphated polycondensation product is involved.

Frequently, the inventive phosphated polycondensation product has a weight-average molecular weight from 4,000 g/mol to 150,000 g/mol, preferably from 10,000 to 100,000 g/mol and more preferably from 20,000 to 75,000 g/mol.

With regard to the phosphated polycondensation products for use with preference in accordance with the present invention, and the preparation thereof, reference is also made to patent applications WO 2006/042709 and WO 2010/040612, the contents of which are hereby incorporated into the application.

Suitably, the polycondensation product is obtainable from a reaction mixture comprising at least
(IIa) a monomer capable of yielding the structural unit (II),
(IIIa) a monomer capable of yielding the structural unit (III),
(IVa) a monomer having an aldehyde group and a phosphating agent.

Desirably the monomer (IIIa) can be reacted with a phosphating agent and the monomer (IIa) so obtained can then be subjected to polycondensation with the monomers (IIIa) and (IVa).

Alternatively, the monomers (IIa), (IIIa) and (IVa) are subjected to polycondensation and the polycondensate obtained is then reacted with a phosphating agent.

In a further alternative form, the monomers (IIa), (IIIa) and (IVa) and the phosphating agent are reacted simultaneously.

Suitably, the polycondensate can be obtainable by a process comprising carrying out the polycondensation and the phosphating in a reaction mixture.

In a further preferred embodiment, the polymer containing acid groups is a vinyl addition polymer. Preferably, * represents the bonding site to the carbon backbone of the polymer containing acid groups. The acid groups would suitably be bonded to said carbon backbone of the polymer.

Preferably, the polymer containing acid groups is at least one copolymer obtainable by polymerizing a mixture of monomers comprising

(V) at least one ethylenically unsaturated monomer comprising at least one radical from the group of carboxylic acid, carboxylic salt, carboxylic ester, carboxamide, carboxylic anhydride and carboximide

and

(VI) at least one ethylenically unsaturated monomer with a polyether group of structural unit (I).

The copolymers according to the present invention contain at least two monomer units. However, it may also be advantageous to use copolymers with three or more monomer units.

In a preferred embodiment, the ethylenically unsaturated monomer (V) is represented by at least one of the following general formulae from groups (Va), (Vb) and (Vc):

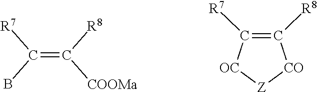

In the mono- or dicarboxylic acid derivative (Va) and the monomer (Vb) in cyclic form, where Z═O (acid anhydride) or NR⁷ (acid imide), R⁷ and R⁸ are each independently hydrogen or an aliphatic hydrocarbyl radical having 1 to 20 carbon atoms, preferably a methyl group. B is H, —COOMₐ, —CO—O(C_{q}H_{2q}O)ᵣ—R⁹, —CO—NH—(C_{q}H_{2q}O)ᵣ—R⁹.

M is hydrogen, a mono- or divalent metal cation, preferably a sodium, potassium, calcium or magnesium ion, or else ammonium or an organic amine radical, and a=½ or 1, according to whether M is a mono- or divalent cation. The organic amine radicals used are preferably substituted ammonium groups which derive from primary, secondary or tertiary C₁₋₂₀-alkylamines, C₁₋₂₀-alkanolamines, C₅₋₈-cycloalkylamines and C₆₋₁₄-arylamines. Examples of the corresponding amines are methylamine, dimethylamine, trimethylamine, ethanolamine, diethanolamine, triethanolamine, methyldiethanolamine, cyclohexylamine, dicyclohexylamine, phenylamine, diphenylamine in the protonated (ammonium) form.

R⁹ is hydrogen, an aliphatic hydrocarbyl radical having 1 to 20 carbon atoms, a cycloaliphatic hydrocarbyl radical having 5 to 8 carbon atoms, an aryl radical having 6 to 14 carbon atoms which may optionally also be substituted, q=2, 3 or 4 and r=0 to 200, preferably 1 to 150. The aliphatic hydrocarbons here may be linear or branched and saturated or unsaturated. Preferred cycloalkyl radicals are considered to be cyclopentyl or cyclohexyl radicals, and preferred aryl radicals to be phenyl or naphthyl radicals, which may especially also be substituted by hydroxyl, carboxyl or sulpho groups.

The following formula represents the monomer (Vc):

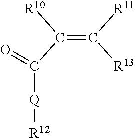

R¹⁰ and R¹¹ here can each independently the hydrogen or an aliphatic hydrocarbyl radical having 1 to 20 carbon atoms, a cycloaliphatic hydrocarbyl radical having 5 to 8 carbon atoms, an optionally substituted aryl radical having 6 to 14 carbon atoms. Q may be the same or different and is represented by NH, NR⁹ or O, where R⁹ is as defined above.

In addition, R¹² can be the same or different and is represented by (CₙH₂ₙ)—SO₃H where n=0, 1, 2, 3 or 4, (CₙH₂ₙ)—OH where n=0, 1, 2, 3 or 4; (CₙH₂ₙ)—PO₃H₂ where n=0, 1, 2, 3 or 4, (CₙH₂ₙ)—OPO₃H₂ where n=0, 1, 2, 3 or 4, (C₆H₄)—SO₃H, (C₆H₄)—PO₃H₂, (C₆H₄)—OPO₃H₂ and (CₙH₂ₙ)—NR¹⁴₂ where n=0, 1, 2, 3 or 4.)

R¹³ can be H, —COOMₐ, —CO—O(C_{q}H_{2q}O)ᵣ—R⁹, —CO—NH—(C_{q}H_{2q}O)ᵣ—R⁹, where Mₐ, R⁹, q and r are each as defined above.

R¹⁴ can be hydrogen, an aliphatic hydrocarbyl radical having 1 to 10 carbon atoms, a cycloaliphatic hydrocarbyl radical having 5 to 8 carbon atoms, an optionally substituted aryl radical having 6 to 14 carbon atoms.

R¹⁵ can be an aliphatic hydrocarbyl radical having 1 to 10 carbon atoms, a cycloaliphatic hydrocarbyl radical having 5 to 8 carbon atoms or an optionally substituted aryl radical having 6 to 14 carbon atoms.

Preferably, the ethylenically unsaturated monomer (V) is any of acrylic acid, or salts thereof, methacrylic acid, or salts thereof, maleic acid, or salts thereof, or maleic anhydride. More preferably, the ethylenically unsaturated monomer (V) is any of acrylic acid, or salts thereof, maleic acid, or salts thereof, or maleic anhydride. More preferably still, the ethylenically unsaturated monomer (V) is acrylic acid or salts thereof.

In a particularly preferred embodiment the ethylenically unsaturated monomer (VI) is represented by the following general formula

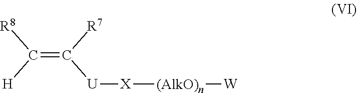

in which each radical is as defined above.

Preferably, in the ethylenically unsaturated monomer (VI) R⁷ and R⁸ are each independently selected from hydrogen, methyl or ethyl. More preferably, R⁷ and R⁸ are both hydrogen.

Preferably, U in the ethylenically unsaturated monomer (VI) represents a chemical bond or an alkylene group having from 1 to 2 carbon atoms, more preferably a chemical bond or a methylene group, more preferably still a chemical bond.

Preferably, X is oxygen.

Preferably, Alk is same or different C₂-C₄ alkylene, preferably containing entirely or predominantly ethylene groups, in which the (AlkO)ₙ has a mean molecular weight Mw from 800 to 8,000, preferably from 1,500 to 5,000, preferably from 2,000 to 4,000, more preferably still from 2,000 to 3,500, in particular from 2,500 to 3,500.

Preferably, Alk is different C₂-C₄ alkylene containing predominantly ethylene groups. More preferably, (AlkO)ₙ is a single butylene oxide unit bonded to a chain of ethylene oxide units, preferably, 1,4-butanediol mono vinyl ether with a polyethylene oxide, in which the polyethylene oxide component contains from 3 to 250 repeating ethylene oxide units, more preferably from 5 to 200 repeating ethylene oxide units, more preferably still from 12 to 150 repeating ethylene oxide units, in particular from 15 to 100 repeating units.

In a further preferred embodiment, Alk is different C₂-C₄ alkylene containing predominantly ethylene groups. More preferably, (AlkO)ₙ is a single butylene oxide unit bonded to a chain of ethylene oxide units, preferably, 1,4-butanediol mono vinyl ether with a polyethylene oxide, in which the polyethylene oxide component contains from 30 to 250 repeating ethylene oxide units, more preferably from 35 to 200 repeating ethylene oxide units, more preferably still from 42 to 150 repeating ethylene oxide units, in particular from 45 to 100 repeating units.

Preferably, the structural unit (VI) is a vinyloxybutyl polyethylene glycol, more preferably comprising a polyethylene glycol having a mean molecular weight Mw from 800 to 8,000, suitably from 800 to 5,000, desirably from 800 to 4,000, more desirably from 1,500 to 4,000, more desirably still from 2,000 to 4,000, more preferably still from 2,000 to 3,500, in particular from 2,500 to 3,500.

The molar ratio of the structural units (V):(VI) is preferably from 1:4 to 15:1, preferably from 1:1 to 10:1.

The preparation of the copolymers is carried out in a conventional way, for example by free-radical polymerization. It is, for example, described in EP0894811, EP1851256, EP2463314, EP0753488.

The inorganic pigment slurry is selected from the group consisting of titanium dioxide slurry, calcium hydroxide slurry, ultrafine precipitated calcium carbonate (PCC) slurry and ground calcium carbonate (GCC) slurry. The invention is particularly suitable for these inorganic pigment slurries which tend to have especially fine particle sizes, especially as these inorganic pigment slurries suitably have a pH of greater the 7. The invention addresses the problem that when producing these specific inorganic pigment slurries it can be difficult to obtain the balance of properties. The invention can be suitable for forming stable and effective aqueous slurries of such inorganic pigments.

In the inventive use, the polymer may be used in doses of up to 3% by weight, based on the total weight of the aqueous inorganic pigment slurry. Generally, though, the optimum dose of the polymer is often below this level. The exact dose may vary according to the particular inorganic pigment, the average particle size of the pigment and the required solids content of the slurry thereof. Typically, the dose may be from 0.05% to 2.5% by weight, for instance from 0.1% to 1% by weight, typically from 0.2% to 0.7% by weight.

Typically, the aqueous inorganic pigment slurry according to the present invention has a pH greater than 7. The pH of the slurry may be at least 8, often at least at least 8.5, for instance at least 9. The pH of the aqueous inorganic pigment slurry may lie in the range from 8 to 12.5 or above.

In one preferred embodiment of the inventive use, the inorganic pigment is calcium hydroxide (d90 below 120 μm, preferably 80 μm and more preferably below 60 μm). Often the calcium hydroxide would have a range of particle sizes. For instance, the d50 can be below 40 μm and usually in the range from 20 μm to 35 μm, for instance from 25 μm to 30 μm. The distribution of particle sizes would normally include very small particles of below 2 μm. Frequently, the volume of calcium hydroxide particles below 2 μm may be as much as 15% or more but usually can be in the range from 2% to 10%, for example from 3% to 8%. The d10 may range from 1 μm to 10 μm, for instance from 2 μm to 10 μm. The d90 may be in the range from 40 μm to 90 μm, for instance from 50 μm to 80 μm, such as from 60 μm to 75 μm. Typically, the aqueous slurry of calcium hydroxide may have a solids content of at least 35% by weight based on the total weight of the slurry, often at least 40% by weight, for instance at least 45% by weight. Suitable calcium hydroxide slurries may have a solids content in the range from 40% to 50% by weight, often from 42% to 48% by weight, for instance from 43% to 47% particularly from 44 to 46%, usually around 45%. Aqueous calcium hydroxide slurries tend to have much higher pH, often above 10.5, for instance from 11 to 12.5. These highly alkaline suspensions are often difficult to achieve effective high solids and low suspensions with conventional dispersants. The polymer employed in accordance with the inventive use have been found to be particularly effective at dispersing calcium hydroxide slurries of high solids and achieving effective low viscosities. Furthermore, the polymer used according to the present invention can achieve stability over prolonged periods of time without any significant loss of viscosity over time by comparison to some conventional dispersants. This is especially so for conventional dispersants which contain an ester link. The dose of the polymer may typically lie in the range from 0.05% to 1.4% by weight, based on the total weight of the slurry. Often the dose may be from 0.1% to 1% by weight, typically from 0.1% to 0.8% by weight, frequently from 0.1% to 0.6% by weight, for instance from 0.2% to 0.4% by weight.

In another preferred embodiment of the invention the inorganic pigment is ultrafine precipitated calcium carbonate (ultrafine PCC). Typically, the aqueous slurry of ultrafine precipitated calcium carbonate may have a solids content of at least 40% by weight based on the total weight of the slurry, often at least 45% by weight, for instance at least 50% by weight. Suitable ultrafine precipitated calcium carbonate (ultrafine PCC) may have a solids content in the range from 40% to 55% by weight, often from 45% to 53% by weight, for instance from 47% to 52% by weight, desirably from 48% to 51% by weight, such as from 48% to 50% by weight, often around 50% by weight. Aqueous precipitated calcium carbonate slurries may have a pH in the range from 8 to 12, often from 8.5 to 11.5, usually from 9 to 11, for instance from 9 to 10.5, typically from 9 to 10. Normally ultrafine precipitated calcium carbonate (ultrafine PCC) may have particles in the range from 0.02 μm to 0.1 μm (from 20 nm to 100 nm). Suitably the mean particle size distribution by weight may range from 0.05 μm to 0.1 μm, for instance from 0.06 μm to 0.1 μm, often from 0.07 μm to 0.09 μm. Some grades of ultrafine calcium carbonate may have a d50 in the range from 80 to 160 nm, for instance from 90 to 150 nm, often from 100 to 140 nm. Such grades may have d90 in the range from 250 nm to 350 nm, for instance from 260 nm to 340 nm, often from 270 nm to 330 nm. Other grades of ultrafine calcium carbonate may have a granule size d50 much larger, for instance from 15 μm to 40 μm, for instance from 20 μm to 35 μm, such as from 20 μm to 30 μm. Typically, such grades may have an average particle size from 20 nm to 100 nm, for instance from 30 nm to 80 nm, such as from 40 nm to 60 nm. The polymer employed in accordance with the inventive use have been found to be particularly effective at dispersing ultrafine precipitated calcium carbonate (ultrafine PCC) slurries of high solids and achieving effective low viscosities. Furthermore, the polymer used according to the present invention can achieve stability over prolonged periods of time without any significant loss of viscosity over time by comparison to some conventional dispersants. The dose of the polymer may typically lie in the range from 0.4% to 3% by weight, based on the total weight of the slurry. Often the dose may be from 0.6 to 2.5% by weight, typically from 0.8% to 2.5% by weight, frequently from 1.0% to 2.0% by weight.

In a further preferred embodiment of the invention the inorganic pigment is ultrafine ground calcium carbonate (ultrafine GCC). Typically, the aqueous slurry of ultrafine ground calcium carbonate may have a solids content of at least 70% by weight based on the total weight of the slurry, often at least 72% by weight, for instance at least 75% by weight, particularly at least 77% by weight. Suitable ultrafine ground calcium carbonate (ultrafine GCC) may have a solids content in the range from 70% to 85% by weight, often from 72% to 80% by weight, for instance from 75% to 79% by weight, desirably from 75% to 78% by weight, such as from 76% to 77% by weight, often around 77% by weight. Aqueous ground calcium carbonate slurries may have a pH in the range from 8 to 11.5, often from 8.5 to 11, usually from 8.5 to 10.5, for instance from 9 to 10. Normally ultrafine ground calcium carbonate (ultrafine GCC) may have a mean particle size (d50) below 5 μm and preferably below 2 μm. The particle size may for instance be between 60% and 99% below 2 μm. It is possible for the ultrafine ground calcium carbonate (ultrafine GCC) to have coatings on the surface of the particles which may provide the ultrafine ground calcium carbonate (ultrafine GCC) with desirable properties, for instance rendering the particles more hydrophobic. However, such coatings can render the product more difficult to produce stable high solids and low viscosity dispersions.

The polymer employed in accordance with the inventive use have been found to be particularly effective at dispersing ultrafine ground calcium carbonate (ultrafine PCC) slurries of high solids and achieving effective low viscosities. Furthermore, the polymer used according to the present invention can achieve stability over prolonged periods of time without any significant loss of viscosity over time by comparison to some conventional dispersants. The dose of the polymer may typically lie in the range from 0.05% to 1.4% by weight, based on the total weight of the slurry. Often the dose may be from 0.1% to 1% by weight, typically from 0.1% to 0.8% by weight, frequently from 0.1% to 0.6% by weight, for instance from 0.2% to 0.4% by weight.

The following examples are intended to illustrate the invention and are not in any way limiting.

### EXAMPLES

The following polymers are used in the examples.

### Product A—Inventive

Product A is prepared employing a heatable reactor equipped with a stirrer is charged with 17.8 parts of polyphosphoric acid and heated to 90° C. Within 15 min, 30.7 parts of phenoxyethanol are metered in while stirring. After 60 min, 445 parts of poly(ethylene oxide) monophenyl ether (mean molecular weight 5,000 g/mol), 34.8 parts of concentrated methanesulphonic acid, 14.16 parts of paraformaldehyde and 23.2 parts of water are added. The reaction mixture is heated to 105° C. while stirring for a further 6 hours. It is then allowed to cool and neutralized to pH 7 with 50% sodium hydroxide solution. The condensation product has a mean molecular weight Mw of approx. 22,000 g/mol (determined by GPC).

### Product B—Commercial Product Melflux® 6685—Inventive

Commercially available polycarboxylate ether from BASF Constructions Additives GmbH. The polymer is based on the monomers acrylic acid and vinyloxybutyl polyethylene glycol—3000.

### Product C—Commercial Product Melflux® PCE 1493—Inventive

Commercially available polycarboxylate ether from BASF Constructions Additives GmbH. The polymer is based on the monomers acrylic acid and vinyloxybutyl polyethylene glycol—3000.

### Product D—Commercial Product Melpers® 2450—Inventive

Commercially available polycarboxylate ether from BASF Construction Additives GmbH. The polymer is based on the monomers maleic anhydride and vinyloxybutyl polyethylene glycol—1100.

### Product E—Inventive

Copolymer of 1.0 molar parts of vinyloxybutyl polyethylene glycol—3000 and 2.7 molar parts of acrylic acid with a mean molecular weight (Mw) of approximately 36,200 g/mol (determined by GPC).

### Product F—Comparative

Copolymer of 1.0 molar parts of methyl end capped polyethylene glycol—1000 methacrylate; 3.7 molar parts of methacrylic acid; and 10.3 molar parts of acrylic acid with a mean molecular weight (Mw) of approximately 9,600 g/mol (determined by GPC).

### Product G—Comparative

Polyacrylic acid, sodium salt prepared using ammonium sulfate starter and isopropanol chain transfer agent, polymer having a mean molecular weight (Mw) of approximately 7,800 g/mol.

### Product H—Comparative

Polyacrylic acid, sodium salt prepared using ammonium persulphate starter and isopropanol chain transfer agent, polymer having a mean molecular weight (Mw) of approximately 3,500 g/mol.

### Product I—Comparative

Polyacrylic acid, sodium salt prepared using ammonium persulphate starter and isopropanol chain transfer agent, polymer having a mean molecular weight (Mw) of approximately 7,800 g/mol.

### Product J—Comparative

Polyacrylic acid, sodium salt prepared using sodium persulphate starter and sodium hypophosphite chain transfer agent, polymer having a mean molecular weight (Mw) of approximately 4,500 g/mol.

### Description of Evaluation Test Work

### Example 1—Formation of Calcium Hydroxide Slurries

### Test Conditions:

45% solid Ca(OH)₂—Company Honeywell Fluka, Standard Goods (Material Number: 31219-500G)
0.2-2.0% solid polymer (Products A-J) (based on mass of Ca(OH)₂ solid)

Particle size specification of the calcium hydroxide is presented in Table 1

TABLE 1

| Particle size | Ca(OH)₂ powder, Fluka |
|---|---|
| d10 | 4.16 μm |
| d50 | 27.7 μm |
| d90 | 68.9 μm |
| Volume <2 μm | 5.6% |

### Test Procedure:

The calculated amount of polymer is solved in demineralized water in 100 ml glass beaker and powder Ca(OH)₂ is added into polymer solution while stirring in approx. 3 minutes. The slurry is stirred for 5 minutes and the viscosity is measured. The viscosity is determined by using Anton Pair MCR-102 with spindle LV 3 at 100 rpm at 23° C.

Devices: Heidolph RZR 2102 control, 32 mm dispersing disc, 100 mL glass beaker, Anton Paar Rheometer MCR 102

The test results are presented in Table 2.

TABLE 2
Calcium Hydroxide Slurries - Viscosity (mPas) at 23° C. -
45% pigments solids by weight based on total weight of slurry

| Polymer | | | | | | | | | | |
|---|---|---|---|---|---|---|---|---|---|---|
| Dose | Product | Product | Product | Product | Product | Product | Product | Product | Product | Product |
| (%) | A | B | C | D | E | F | G | H | I | J |
| 0.2 | 155 | 571 | 315 | 376 | 257 | 426 | 1342 | 1074 | 1555 | Solid |
| 0.3 | Not | Not | Not | Not | Not | 243 | Not | Not | Not | Solid |
| | tested | tested | tested | tested | tested | | tested | tested | tested | |
| 0.4 | 49 | 57 | 59 | 187 | 61 | 110 | 917 | 931 | 601 | Solid |
| 0.5 | Not | Not | Not | Not | Not | 68 | Not | Not | Not | Solid |
| | tested | tested | tested | tested | tested | | tested | tested | tested | |
| 0.6 | 17 | 34 | 20 | 94 | 20 | 27 | 596 | 760 | 980 | Solid |
| 0.7 | Not | Not | Not | Not | Not | 29 | Not | Not | Not | Solid |
| | tested | tested | tested | tested | tested | | tested | tested | tested | |
| 0.8 | 26 | 34 | 24 | 103 | 36 | 36 | 385 | 568 | 852 | Solid |
| 0.9 | No | Not | Not | Not | Not | 13 | Not | Not | Not | 269 |
| | tested | tested | tested | tested | tested | | tested | tested | tested | |
| 1.0 | 12 | 23 | 9 | 70 | 34 | Not | 249 | 398 | 701 | 176 |
| | | | | | | tested | | | | |
| 1.1 | Not | Not | Not | Not | Not | Not | Not | Not | Not | 86 |
| | tested | tested | tested | tested | tested | tested | tested | tested | tested | |
| 1.2 | Not | 10 | 31 | 66 | 14 | 29 | 144 | 442 | 679 | 66 |
| | tested | | | | | | | | | |
| 1.3 | Not | Not | Not | Not | Not | <0 | Not | Not | Not | Not |
| | tested | tested | tested | tested | tested | | tested | tested | tested | tested |
| 1.4 | 20 | 8 | 33 | 60 | 15 | Not | 72 | 215 | 598 | 47 |
| | | | | | | tested | | | | |
| 1.5 | Not | Not | Not | Not | Not | Not | Not | Not | Not | Not |
| | tested | tested | tested | tested | tested | tested | tested | tested | tested | tested |
| 1.6 | Not | 17 | 29 | 47 | 36 | Not | 50 | 89 | 441 | 27 |
| | tested | | | | | tested | | | | |
| 1.7 | Not | Not | Not | Not | Not | Not | Not | Not | Not | <0 |
| | tested | tested | tested | tested | tested | tested | tested | tested | tested | |
| 1.8 | 12 | 31 | 16 | 44 | 35 | Not | 31 | 36 | 362 | Not |
| | | | | | | tested | | | | tested |
| 1.9 | Not | Not | Not | Not | Not | Not | Not | Not | Not | Not |
| | tested | tested | tested | tested | tested | tested | tested | tested | tested | tested |
| 2.0 | 31 | 7 | 33 | 53 | 35 | Not | 14 | 41 | 266 | Not |
| | | | | | | tested | | | | tested |

The results in Table 2 illustrate that for the preparation of 45% solids calcium hydroxide slurries, Product A should the best performing dispersing agent, achieving the lowest viscosity value at 0.2% w/w polymer. By contrast comparative tests using standard polyacrylate products G-J required many times more polymer (more than 5 times the amount of polymer in the case of the best performing of these, Product G, to achieve the same viscosity as for Product A and more than 4 times the amount of polymer required for Product E. Comparative polyether polymer Product F required between 1.5 and twice as much polymer as required for inventive Product A.

### Example 2—Formation of Ultrafine Calcium Carbonate Slurries

### Test Conditions:

50% solid ultrafine calcium carbonate (in a filtered cake/paste form)
1.0-2.0% solid polymer (based on ultrafine calcium carbonate)

Specification of ultrafine calcium carbonate is presented in Table 3

TABLE 3

| Technical specifications | Unit | Value |
|---|---|---|
| Moisture | % | <1 |
| Bulk density | g/cm³ | 0.75 |
| pH | | 7-9 |
| Appearance (25° C.) | | white powder |
| Granule size d50% | μm | 25 |
| Particle size d50% | nm | Approx 130 |
| Particle size d90% | nm | Approx 300 |

### Test Procedure:

Application: 80-90 g of the ultrafine calcium carbonate paste is weighed into a PE cup. As a dispersing agent, 0.5% polymer (based on solids) is weighed in. The mixture is then stirred manually until it is completely liquid dispersion. The base is then refilled into an 80 mL PE cup and re-stirred for 5 minutes more with a dispersing disc at 1500 rpm to obtain homogenous dispersion.

Sample is tested with Anton Paar Rheometer MCR 102 with Brookfield Adapter and Spindle LV 3 measured at 100 rpm at 23° C. The sample is stored and measured again after 5 h and 24 h.

Devices: Heidolph RZR 2102 control, 32 mm dispersing disc, 80 mL PE cup, Anton Paar Rheometer MCR 102

The results are presented in Table 4.

Conventional comparative polyacrylate Products G-J do not provide the effectiveness as the polymers according to the present invention. The best performing product is Product A at 1% w/w the dosage level. The closest 2nd best performance can be seen from Product D. Polycarboxylate Products G-J do not come close to Product A even when twice as much polymer is used.

### Example 3—Formation of Ground Calcium Carbonate Slurries

### Test Conditions:

77% solid CaCO3 OmyaCarb 2-GU (particle size distribution d50=3.8 microns; d90=9.6 microns);
0.2% solid polymer (based on CaCO3 solid)

Specification of ground calcium carbonate is presented in Table 5

TABLE 5

| Particle size | Ground Calcium Carbonate (GCC) |
|---|---|
| d10 | 0.774 μm |
| d50 | 3.86 μm |
| d90 | 9.69 μm |
| Volume <2 μm | 26.57% |

### Test Procedure:

The calculated amount of polymer is solved in demineralized water in 100 ml glass beaker and powder CaCO₃ is added into polymer solution while stirring in approx. 3 minutes. The slurry is stirred for 5 minutes and the viscosity is measured. The viscosity is determined by using Anton Pair MCR-102 with spindle LV 3 at 100 rpm at 23° C.

Devices: Heidolph RZR 2102 control, 32 mm dispersing disc, 100 mL glass beaker, Anton Paar Rheometer MCR 102.

The results are presented in Table 6.

Product A gave the best overall viscosity and stability over 24 hours. The other polymers of the invention, Products B-E also provided good viscosities and stability over 24 hours. The comparative polyacrylate Product J appeared to provide acceptable viscosities initially but sedimented after 24 hours. Comparative polyether Product F appeared to provide an initial acceptable viscosity but very quickly showed increase in viscosity with time such that at 24 hours the viscosity had increased quite significantly to 1,160 mPas which would be unsuitable for use and indicates declining stability.

TABLE 4
Ultrafine Calcium Carbonate Slurries - Viscosity (mPas) at 23°
C. - 50% by weight pigment solids based on total weight of slurry

| Polymer | | | | | | | | | | |
|---|---|---|---|---|---|---|---|---|---|---|
| Dose | Product | Product | Product | Product | Product | Product | Product | Product | Product | Product |
| (%) | A | B | C | D | E | F | G | H | I | J |
| 1.0 | 91 | Solid | Solid | 691 | Solid | Solid | Solid | Solid | Solid | Solid |
| 1.5 | 109 | 111 | 1228 | 165 | 402 | 301 | Solid | Solid | Solid | Solid |
| 2.0 | 99 | 149 | 335 | <0 | 387 | 358 | 2369 | Solid | 1618 | Solid |

TABLE 6
Ground Calcium Carbonate Slurries - Viscosity (mPas) at 23° C. - 77% by
weight pigment solids based on total weight of slurry at a fixed dose of 0.2% w/w.

| Time | Product | Product | Product | Product | Product | Product | Product |
|---|---|---|---|---|---|---|---|
| (hours) | A | B | C | D | E | F | J |
| 0 | 287 | 340 | 333 | 333 | 380 | 265 | 317 |
| 1 | 340 | 428 | 324 | 378 | 517 | 520 | 399 |
| 5 | 343 | 417 | 369 | 445 | 560 | 644 | 371 |
| 24 | 404 | 467 | 424 | 558 | 681 | 1160 | Sedimented |

1. A polymer containing acid groups as a dispersant for stabilising an aqueous inorganic pigment slurry, wherein the polymer containing acid groups comprises polyether groups of the structural unit (I) 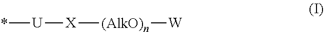
where
* indicates a bonding site to the polymer containing acid groups,
U represents a chemical bond or an alkylene group having 1 to 8 carbon atoms,
X is oxygen or an NR¹ group,
n is an integer with a mean, based on the polymer containing acid groups, in a range from 3 to 300,
Alk is C₂-C₄-alkylene, where Alk may be the same or different within the (Alk-O)ₙ group,
W is a hydrogen, C₁-C₆-alkyl, or aryl radical or is the Y—F group where
Y is a linear or branched alkylene group which has 2 to 8 carbon atoms and may bear a phenyl ring,
F is a nitrogen-bonded 5- to 10-membered nitrogen heterocycle which may have, as ring members, as well as the nitrogen atom and as well as carbon atoms, 1, 2, or 3 additional heteroatoms selected from oxygen, nitrogen, and sulphur, where the nitrogen ring members may have an R² group, and where 1 or 2 carbon ring members may be in the form of carbonyl groups,
R¹ is hydrogen, C₁-C₄-alkyl, or benzyl, and
R² is hydrogen, C₁-C₄-alkyl, or benzyl,
wherein the inorganic pigment slurry is selected from the group consisting of a titanium dioxide slurry, a calcium hydroxide slurry, an ultrafine precipitated calcium carbonate (PCC) slurry, and a ground calcium carbonate (GCC) slurry.

2. The polymer according to claim 1, wherein the acid group of the polymer is at least one from the group of carboxyl, aromatic acids, carbolic acids, phosphono, sulphino, sulpho, sulphamido, sulphoxy, sulphoalkyloxy, sulphinoalkyloxy, and phosphonooxy group.

3. The polymer according to claim 1, wherein the polymer containing acid groups is a polycondensation product comprising
(II) a structural unit having an aromatic or heteroaromatic system and a polyether group of the formula (I), and
(III) a phosphated structural unit having an aromatic or heteroaromatic system.

4. The polymer according to claim 3, wherein the structural units (II) and (III) are represented by the following general formulae 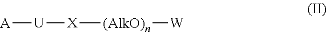
where
A is the same or different and is represented by a substituted or unsubstituted, aromatic or heteroaromatic compound having 5 to 10 carbon atoms in the aromatic system, where the further radicals are as defined for structural unit (I); 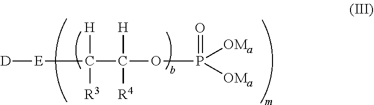
where
D is the same or different and is represented by a substituted or unsubstituted, aromatic or heteroaromatic compound having 5 to 10 carbon atoms in the aromatic system
where
E is the same or different and is represented by N, NH, or O
where
m=2 if E=N and m=1 if E=NH or O
where
R³ and R⁴ are the same or different and are each independently represented
by a branched or unbranched C₁- to C₁₀-alkyl radical, C₅- to C₈-cycloalkyl radical, aryl radical, heteroaryl radical, or H
where b
is the same or different and is represented by an integer from 0 to 300
where
M is independently of one another alkali metal ion, alkaline earth metal ion, ammonium ion, organic ammonium ion, and/or H, a is 1 or in the case of alkaline earth metal ions 1/2.

5. The polymer according to claim 3, wherein the polycondensation product contains a further structural unit (IV) which is represented by the following formula 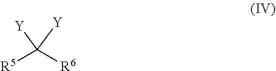
where
Y is the same or different and is independently represented by (II), (III) or further constituents of the polycondensation product,
where
R⁵ and R⁶ are preferably the same or different and are represented by H, CH₃, COOH, or a substituted or unsubstituted, aromatic or heteroaromatic compound having 5 to 10 carbon atoms.

6. The polymer according to claim 4, wherein the structural units (II) and (III) are represented by the following general formulae 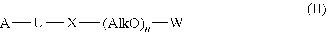
where
A is the same or different and is represented by a substituted or unsubstituted, phenyl group, where the further radicals are as defined for structural unit (I); 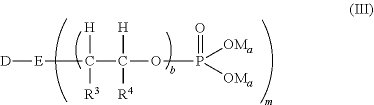
where
D is the same or different and is represented by a substituted or unsubstituted, phenyl group
where
E is the same or different and is represented by O
where
m=1.

7. The polymer according to claim 4, wherein the structural unit (II) is represented by the following general formula 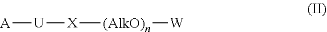
where
A is the same or different and is represented by a substituted or unsubstituted phenyl group,
where
U is a single bond
where
X=O
where
AlkO is an ethyleneoxy and/or propyleneoxy unit,
where
n is in a range of from 10 to 150,
where
W=H.

8. The polymer according to claim 4, wherein the condensation product also comprises structural unit (VII) which is represented by the following general formula 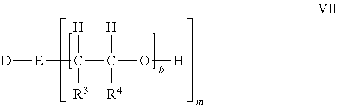
wherein D, E, R³, R⁴, b, and m have the same meanings as defined in regard to formula (II).

9. The polymer according to claim 3 where a ratio of structural unit (II): structural unit (III) is from 10:1 to 1.

10. The polymer according to claim 5 where a ratio of structural unit (II): is from 10:1 to 1:10.

11. The polymer according to claim 3, wherein the polycondensation product is obtainable from a reaction mixture comprising at least
(IIa) a monomer capable of yielding the structural unit (II),
(IIIa) a monomer capable of yielding the structural unit (III),
(IVa) a monomer having an aldehyde group and a phosphating agent.

12. The polymer according to claim 11, wherein the monomer (IIIa) is first reacted with a phosphating agent and the monomer (IIa) thus obtained is subjected to polycondensation with the monomers (IIIa) and (IVa).

13. The polymer according to claim 11, wherein the monomers (IIa), (IIIa), and (IVa) are subjected to polycondensation and the polycondensate obtained is then reacted with a phosphating agent.

14. The polymer according to claim 11, wherein the monomers (IIa), (IIIa), and (IVa) and the phosphating agent are reacted simultaneously.

15. The polymer according to claim 3, wherein the polycondensate is obtainable by a process comprising carrying out the polycondensation and the phosphation in a reaction mixture.

16. The polymer according to claim 1, wherein the polymer containing acid groups is at least one copolymer obtainable by polymerizing a mixture of monomers comprising
(V) at least one ethylenically unsaturated monomer comprising at least one radical from the group of carboxylic acid, carboxylic salt, carboxylic ester, carboxamide, carboxylic anhydride, and carboximide
and
(VI) at least one ethylenically unsaturated monomer with a polyether group of structural unit (I).

17. The polymer according to claim 16, wherein the ethylenically unsaturated monomer (V) is represented by at least one of the following general formulae from groups (Va), (Vb), and (Vc) 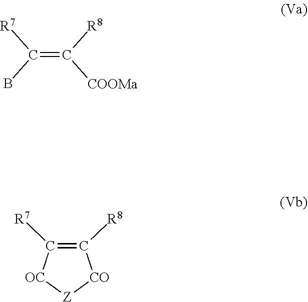
where
R⁷ and R⁸ are each independently hydrogen or an aliphatic hydrocarbyl radical having 1 to 20 carbon atoms,
B is H, —COOMₐ, —CO—O(C_{q}H_{2q}O)ᵣ—R⁹, —CO—NH—(C_{q}H_{2q}O)—R⁹
M is hydrogen, a mono- or divalent metal cation, an ammonium ion, or an organic amine radical,
a is ½ or 1
R⁹ is hydrogen, an aliphatic hydrocarbyl radical having 1 to 20 carbon atoms, a cycloaliphatic hydrocarbyl radical having 5 to 8 carbon atoms, an optionally substituted aryl radical having 6 to 14 carbon atoms,
q for each (C_{q}H_{2q}O) unit is the same or different and is independently 2, 3, or 4 and
r is 0 to 200
Z is O, NR³, 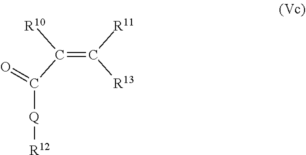
where
R¹⁰ and R¹¹ are each independently hydrogen or an aliphatic hydrocarbyl radical having 1 to 20 carbon atoms, a cycloaliphatic hydrocarbyl radical having 5 to 8 carbon atoms, an optionally substituted aryl radical having 6 to 14 carbon atoms,
R¹² is the same or different and is represented by (CₙH₂ₙ)—SO₃H where n=0, 1, 2, 3, or 4, (CₙH₂ₙ)—OH where n=0, 1, 2, 3, or 4; (CₙH₂ₙ)—PO₃H₂ where n=0, 1, 2, 3, or 4, (CₙH₂ₙ)—OPO₃H₂ where n=0, 1, 2, 3, or 4, (C₆H₄)—SO₃H, (C₆H₄)—PO₃H₂, (C₆H₄)—OPO₃H₂ and (CₙH₂ₙ)—NR¹⁴_{b}, where n=0, 1, 2, 3, or 4 and b=2 or 3,
R¹³ is H, —COOMₐ, —CO—O(C_{q}H_{2q}O)ᵣ—R⁹, —CO—NH—(C_{q}H_{2q}O)ᵣ—R⁹, where Mₐ, R⁹, q and r are each as defined above,
R¹⁴ is hydrogen, an aliphatic hydrocarbyl radical having 1 to 10 carbon atoms, a cycloaliphatic hydrocarbyl radical having 5 to 8 carbon atoms, an optionally substituted aryl radical having 6 to 14 carbon atoms,
Q is the same or different and is represented by NH, NR¹⁵ or O; where R¹⁵ is an aliphatic hydrocarbyl radical having 1 to 10 carbon atoms, a cycloaliphatic hydrocarbyl radical having 5 to 8 carbon atoms or an optionally substituted aryl radical having 6 to 14 carbon atoms.

18. The polymer according to claim 16, wherein the ethylenically unsaturated monomer (VI) is represented by the following general formula 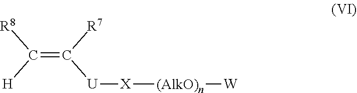
in which
each radical is as defined above.

19. The polymer according to claim 16, in which the structural unit (VI) is a vinyloxybutyl polyethylene glycol, preferably comprising a polyethylene glycol having a mean molecular weight Mw from 800 to 4,000, more preferably from 2,000 to 4,000.

20. The polymer according to claim 1, wherein the inorganic pigment is calcium hydroxide and is present in the slurry in an amount of at least 45% solids.

21. The polymer according to claim 1, wherein the inorganic pigment is ultrafine precipitated calcium carbonate (PCC) and is present in the slurry in an amount of at least 50% solids.

22. The polymer according to claim 1, wherein the inorganic pigment is a ground calcium carbonate (GCC) and is present in the slurry in an amount of at least 50% solids.

23. A method of stabilizing an aqueous inorganic pigment slurry comprising adding a polymer of claim 1 to the inorganic pigment slurry.
